(19) United States
(12) Patent Application Publication
(10) Pub. No.: US 2009/0032337 A1
(43) Pub. Date: Feb. 5, 2009

(54) Lubricant grease supplying system and method of supplying lubricant grease using the system

(76) Inventor: David John Scott, Washington, IL (US)

Correspondence Address: WENDEROTH, LIND & PONACK, L.L.P., 2033 K STREET N. W., SUITE 800, WASHINGTON, DC, 20006-1021, US

(21) Appl. No.: 11/882,563

(22) Filed: Aug. 2, 2007

(51) Int. Cl. F16K 31/02; F16N 7/36; G01F 22/00

(52) U.S. Cl. 184/26; 137/315.03; 73/426

(57) ABSTRACT

An automatic remote grease reservoir filling system is provided for mobile machinery which has an installed automatic grease lubrication system. The filling system allows for an indication of low, prior to empty, reservoir quantity status to an operator station of the mobile machinery, which in turn allows for maintenance refill planning to occur in parallel with continued machine operation. An indication of full reservoir status can be made known remotely in the vicinity of a remote fill point, and other points as desired, distanced physically and or visually from the reservoir. Refill operations can be made remotely at the remote fill point which is distanced physically and or visually from the reservoir. Refill of the reservoir will stop automatically when full capacity is reached, prior to spillage. A replenishment flow can be manually shutoff at the fill point even though external supply flow pressure continues.

### FIELD OF THE INVENTION

The present invention relates to a system for automatically supplying lubricant grease to lubricate non-engine components of mobile machinery, and to a method for automatically supplying lubricant grease to lubricate non-engine components of mobile machinery.

### BACKGROUND OF THE INVENTION

An automatic grease lubrication system (hereinafter referred to as AGLS) on mobile machinery requires use of a holding reservoir which, during course of machine operation, eventually becomes depleted such that required is replenishment of the holding reservoir for continued operation of the AGLS. This holding reservoir usually is also mounting structure for AGLS components. Some manufacturers may also produce and package reservoir assemblies including nearly all of required critical AGLS components as a single pre-assembled part.

The AGLS reservoir may be mounted on mobile machinery in locations which are not easily accessible, and resulting accessibility problems may cause undesirable effects with regard to maintenance operations for those machines having a so installed AGLS. These accessibility problems may include: a) significant time is used in gaining access to the AGLS reservoir; b) safety inherently has more risk over time as spillage occurs on an access route to the AGLS reservoir; c) significant manpower time is used during AGLS reservoir refill operations because manual observation procedures are necessary; d) highly physically capable persons may be required to reach the AGLS reservoir location for performance of refill operations; and e) safety associated with refilling such a difficult to access AGLS reservoir inherently has higher risks than other refill operations due to climbing and access route requirements in gaining access to an AGLS reservoir refill location.

Operation of the AGLS requires the AGLS reservoir to have a sufficient level of lubricant grease such that an AGLS pump is capable to distribute the lubricant grease as functionally intended. Should the level of lubricant grease in the AGLS reservoir become excessively low, then a failure of the AGLS results in that the AGLS is not able to distribute the lubricating grease. Should the level of lubricant grease in the AGLS reservoir be at an excessively low level, then air may enter into the AGLS pump and downstream AGLS components. When air enters the AGLS pump and downstream AGLS components, several undesirable problems may occur which include: a) damage to AGLS components; and b) purging of the air from the AGLS pump and from the downstream AGLS components may be needed which requires significant manpower time.

A simple AGLS reservoir remote supply connection point, ported by a hose or tube, would seem to be a simple solution, but this inherently has many problems which include: a) the AGLS reservoir may become pressurized which in turn may cause spillage and may cause other undesired pressurization risks; b) continuous monitoring and watching for indication of the AGLS reservoir reaching full capacity is required, and failure to monitor may cause lubricating grease spillage and undesired damage to AGLS components; c) monitoring of the AGLS reservoir lubricant volume level may not be readily and easily performable when the AGLS reservoir is remotely located; and d) damage to the AGLS reservoir and other AGLS components may occur if the AGLS reservoir overflow exit porting has restrictions which in turn cause undesired pressurization of the AGLS reservoir.

Therefore, what is needed is an automatic remote grease filling system for mobile machinery which has an AGLS installed. It is desired for an automatic remote grease filling system to reduce or eliminate AGLS reservoir filling problems such as those mentioned above.

### SUMMARY OF THE INVENTION

A general object of the present invention is to provide structure by which an AGLS reservoir may be replenished with lubricant grease from a connection point which is remotely distanced by either or both of visual site and physical distance, which structure will allow for automatic non-human required monitoring for each occurrence that AGLS reservoir replenishment is performed.

In accordance with a first aspect of the invention, structure is provided for automatically stopping filling of the AGLS reservoir with lubricant grease when the AGLS reservoir is filled to capacity (i.e. before overflowing of the AGLS reservoir results), and when an electrical circuit power failure occurs.

In accordance with a second aspect of the invention, an indicator for indicating whether AGLS reservoir replenishment is complete (AGLS reservoir full), or replenishment is required (AGLS reservoir near empty), may be located in the vicinity of a remote filling location point, or any other remote point or points on the mobile machine, as may be desired. These other remote points include a mobile machine operator station.

Principles and features of this invention may be employed in varied and numerous embodiments without departing from the scope of the invention. The above and other features of the invention, including various and novel details of construction and combination of parts, will be fully described with reference to accompanying drawings. It is to be understood that particular features embodying the invention are shown by way of illustration only and not as a limitation of the invention.

### BRIEF DESCRIPTION OF THE DRAWINGS

Aspects of illustrative embodiments of the present invention are non-limiting embodiments. These aspects will be apparent by the descriptions in detail thereof with reference to the attached drawings in which:

FIG. 1 is an overall schematic view of a grease replenishment system according to the invention.

FIG. 2 shows an input line of the grease replenishment system in detail.

FIG. 3(a) is a schematic illustration of an electric circuit associated with a low level sensor of the grease replenishment system.

FIG. 3(b) is a schematic illustration of an electric circuit associated with a high level sensor of the grease replenishment system.

FIG. 4 shows an indicator lamp of the grease replenishment system.

FIG. 4(b) shows a lens of the indicator lamp of FIG. 4(a) in greater detail.

### DETAILED DESCRIPTION OF THE PREFERRED EMBODIMENTS

The following description of the invention discloses specific configurations, features, and operations. However, the description is merely an example of the present invention, and thus, specific features described below are merely used for purposes to more easily describe the invention and provide an overall understanding of the invention.

Accordingly, one skilled in the art will readily recognize that the present invention is not limited to the specific embodiments described below. Furthermore, description of various configurations, features, and operations of the present invention fully understandable to one skilled in the art are omitted for the sake of clarity and brevity. Also, it is to be understood that phraseology and terminology, and the example employed herein is for the purpose of description and should not be regarded as limiting.

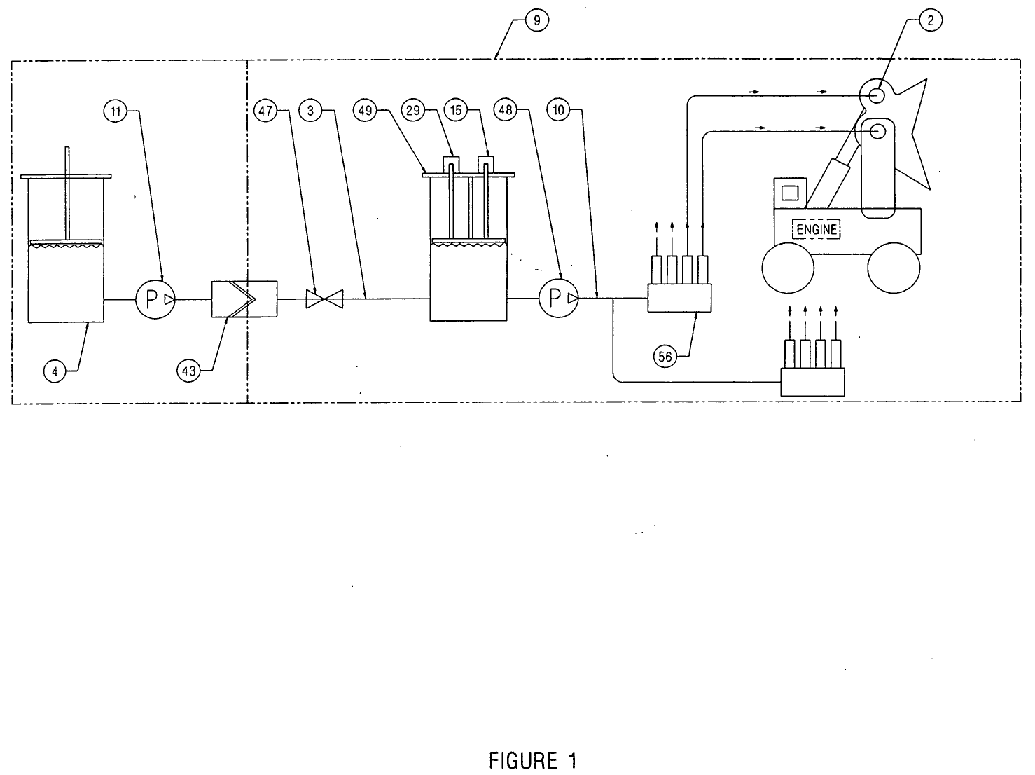

As shown in FIG. 1, a grease replenishment system comprises a source of grease 4 and a mobile machine 9 including a non-engine component 2 and a system for supplying grease to the non-engine component. The system for supplying grease includes a reservoir 49 (AGLS reservoir) for storing grease, an output line 10, an input line 3, a solenoid valve 47 in the input line 3, a first sensor 29 within the reservoir 49, and a second sensor 15 within the reservoir 49. The first sensor 29 is for sensing when grease within the reservoir 49 has attained a first level (indicating that reservoir 49 is full), and the second sensor 15 is for sensing when the grease within the reservoir has been depleted to a second level (indicating that the reservoir is close to being empty). Though not shown in FIG. 1, and to later be described in more detail, lamps are electrically connected to the first and second sensors 29, 15, to indicate conditions sensed thereby. These lamps can be positioned at various locations including the vicinity of a filling point at which grease supplied from source 4 enters reservoir 49 via input line 3, within an operator cabin of the mobile machinery, and any other appropriately visible location on the mobile machinery.

In operation, when grease is to be supplied from the reservoir 49 to the non-engine component 2, pump 48 is activated such that grease is pumped from reservoir 49 through output line 10 to component 2 via manifold 56. The amount of manifolds 56 is dependent upon the amount of non-engine components 2 and their location. When the reservoir 49 becomes sufficiently depleted such that replenishment thereof is needed for continued normal operation, a solenoid valve 47 in the input line 3 is opened and grease is pumped by pump 11 from source of grease 4 through the input line 3 and into reservoir 49. Upon the first sensor 29 sensing that grease within the reservoir 49 has attained the first level (indicating that reservoir 49 has been replenished), the valve 47 is automatically closed to prevent additional grease from being supplied into the reservoir. The source of grease 4 can be either a mobile supply truck or a stationary supply station.

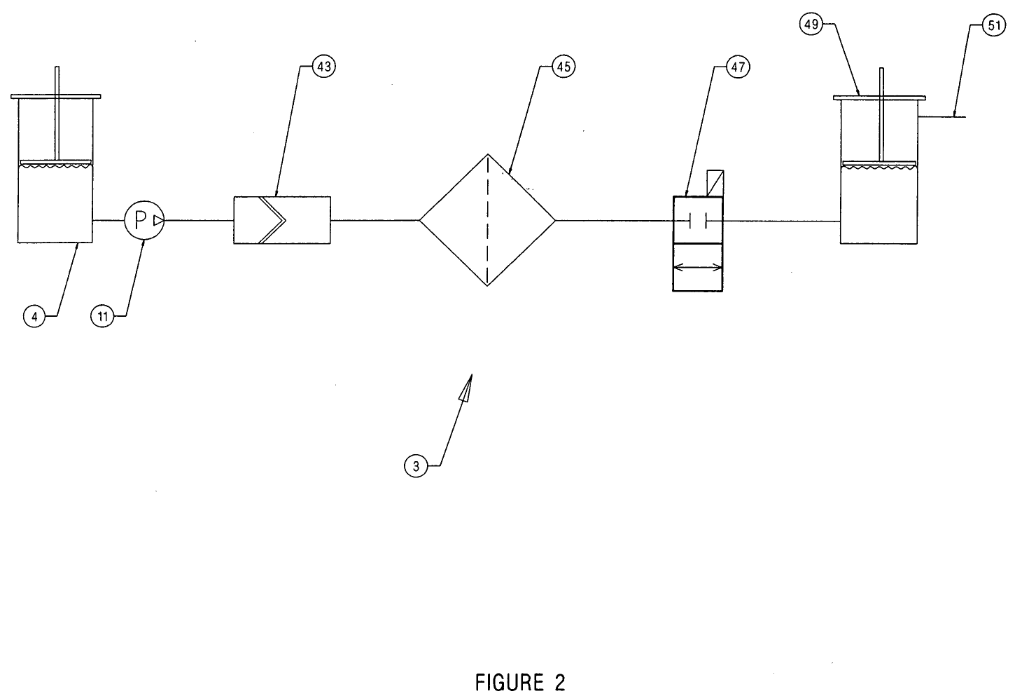

The input line 3 is shown in more detail in FIG. 2. As shown in FIG. 2, a coupling 43 is provided for connecting the input line to the source of grease 4, and a filter 45 is provided in the input line 3 to remove impurities and particulate matter from the grease prior to the grease reaching the reservoir 49. The solenoid valve 47 is shown to have a pressure release function for releasing pressure from the input line 3 upon closing of the valve; however, this pressure release function can be incorporated at other positions of the input line 3. Also as shown in FIG. 2, the reservoir 49 includes an overflow vent 51.

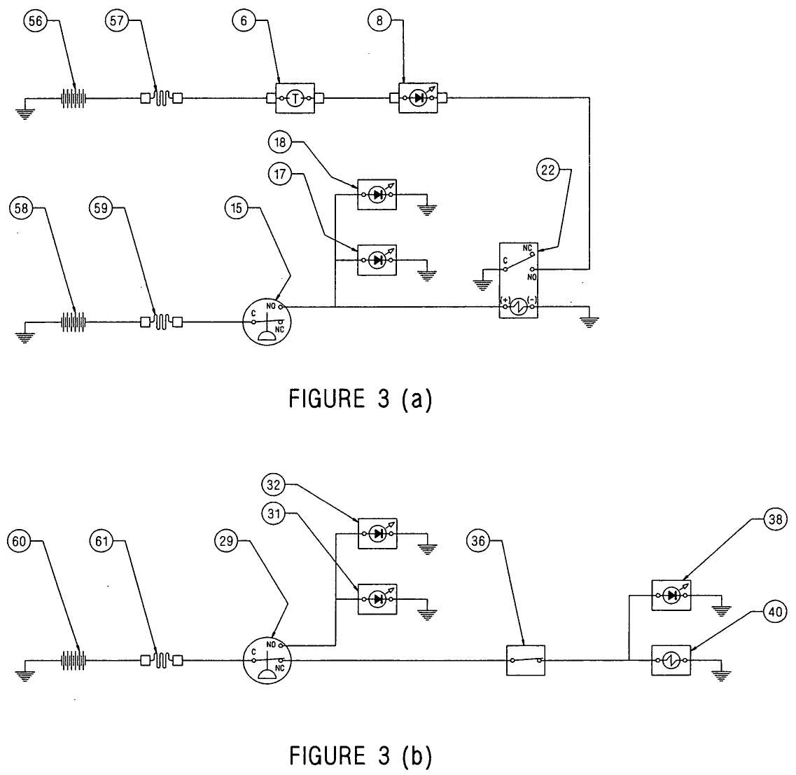

FIG. 3(a) is a schematic illustration of an electric circuit associated with the second sensor 15 (low level sensor) of the grease replenishment system, and FIG. 3(b) is a schematic illustration of an electric circuit associated with the first sensor 29 (high level sensor) of the grease replenishment system. In FIG. 3(a), reference numeral 8 represents a lamp within the operator cabin of the mobile machinery for indicating when the second sensor (electrical switch) 15 senses that the grease within the reservoir 49 has been depleted to the second level, reference numeral 18 represents a lamp in the vicinity of the filling point at which grease supplied from source 4 enters reservoir 49 for indicating when the second sensor (electrical switch) 15 senses that the grease within the reservoir 49 has been depleted to the second level, and reference numeral 17 represents a lamp at a remote location on the mobile machine for indicating when the second sensor (electrical switch) 15 senses that the grease within the reservoir 49 has been depleted to the second level. Similarly, in FIG. 3(b) reference numeral 32 represents a lamp in the vicinity of the filling point at which grease supplied from source 4 enters reservoir 49 for indicating when the first sensor (electrical switch) 29 senses that the grease within the reservoir 49 is at the first level, and reference numeral 31 represents a lamp at the remote location on the mobile machine for indicating when the first sensor (electrical switch) 29 senses that the grease within the reservoir 49 is at the first level. These electric circuits include batteries (56, 58, 60) and fuses (57, 59, 61).

Before beginning a process for supplying lubricant grease to AGLS reservoir 49, a person may first ascertain if the AGLS reservoir requires filling. That is, corresponding ones of lamps 8, 17, 18, 31 and 32 are examined to determine whether lubricant grease should be supplied to the AGLS reservoir. For example, if the lamp 32 is active indicating that the AGLS reservoir is at full capacity, then replenishment of the AGLS reservoir is not required. If the lamp 32 is inactive and the lamp 18 is inactive with all required power circuits functional and active, then this indicates that an urgent attention AGLS capacity has not been reached and replenishment of the AGLS reservoir can be performed at a later time, depending upon necessity, convenience and efficiency concerns. If any of the lamps 8, 17 and 18 are active, then this indicates that moderately quick attention is required by a maintenance person for replenishment of the AGLS reservoir.

Once it has been determined that an AGLS reservoir refill operation is required, a maintenance procedure may continue. For filling of the AGLS reservoir, first a mechanical connection is made between the supply source of lubricant grease 4 and the input line 3 via coupling 43 (FIG. 2). Typical supply sources are a maintenance shop supply or a maintenance mobile truck supply. Next, pressurization of the input line 3 is accomplished from the supply source 4; however, no flow is expected at this time because the valve 47 is closed since no electrical power is being supplied to solenoid 40 (FIG. 3(b)). Electrical power is then supplied to the solenoid 40 by closing switch 36 which is located near the coupling 43, such that a closed circuit is provide whereby valve 47 is opened and lubricant grease begins to be forced into the AGLS reservoir via pump 11. Alternatively, a latching relay control with a series of switches for start and stop and combinations thereof can be provided in place of the switch 36.

Once a full capacity volume level of the AGLS reservoir 49 is obtained, the electrical switch 29 opens, whereby the closed circuit becomes an open circuit such that no power is supplied to the solenoid 40 and the valve 47 closes to prevent further supply of lubricant grease into the AGLS reservoir. Such automatic stoppage of supply of lubricant grease into the AGLS reservoir prevents lubricant grease from flowing through overflow vent 51 of the AGLS reservoir, and thereby prevents problems associated with such overflowing.

This opening of switch 29 results in a second circuit being closed, whereby power is supplied to the lamps 31 and 32 such that these lamps are illuminated, thereby indicating that the AGLS reservoir is full.

In addition to the lamps 18 and 32 in the vicinity of the filling point at which grease supplied from source 4 enters reservoir 49, there may also be a functionality lamp 38 to indicate when the solenoid 40 has power supplied thereto. This can serve as a check for confirming that switches 29 and 36 are closed.

Provision of lamp 8 in the operator cabin provides a benefit in that closing of the electrical switch 15 results in a ground signal through use of relay 22, which is closed so as to close a third circuit, whereby provided is a ground to the lamp 8 which has in line therewith a flasher 6, which is in turn connected to power. This lamp 8 will provide the operator with an indication of a low level of lubricant grease in the AGLS reservoir 49 so as to allow the operator to notify maintenance personnel of such a condition during machine operation but prior to an actual event of AGLS reservoir exhaustion. This allows for increased machine availability because the machine continues to operate normally while at the same time allowing the maintenance personnel to undertake actions to prepare for replenishment of the AGLS immediately upon AGLS reservoir exhaustion. Additionally, the relay 22 can close the third circuit in response to some fault or malfunction with the system (without the level of lubricant grease in the reservoir being low) such that the operator can be informed of this fault or malfunction and take appropriate action.

The valve 47 has internal to its design a manual bypass function. This allows for the input line 3 to be momentarily vented to low pressure, if required, so that the coupling 43 may be disconnected.

An output port of the valve 47 is then plumbed to an inlet on the AGLS reservoir. An overflow venting port on the AGLS reservoir is plumbed for open atmosphere so as to avoid pressurization of the AGLS reservoir 49, should such occur through unknown system failures or modifications.

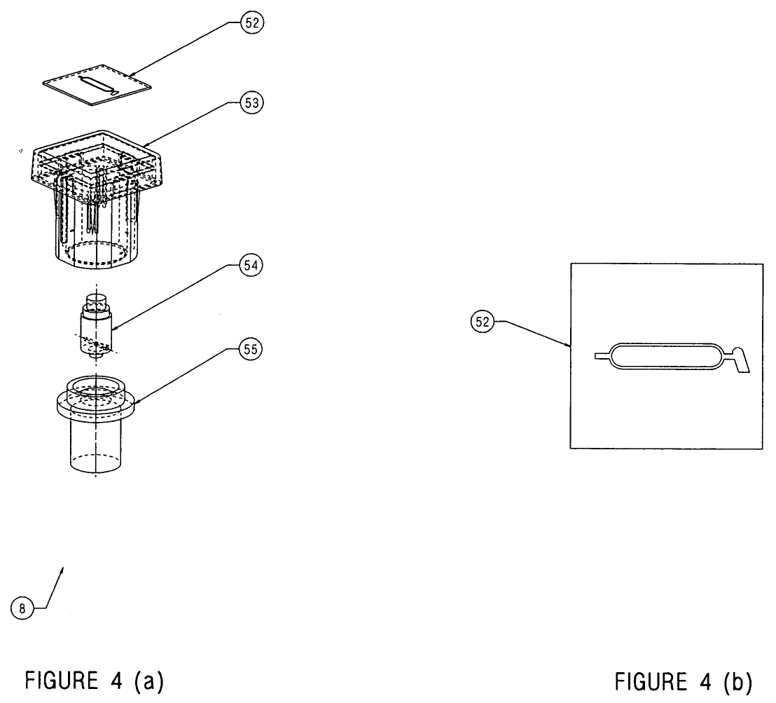

As shown in FIG. 4(a), lamp 8 includes a bulb holder connector 55, an LED white bulb 54, a lens body 53 including a diffuser, and a decal symbol lens 52. The bulb 54 is held by the bulb holder connector 55, the lens body 53 is placed over the bulb, and the decal symbol lens 52 is placed on the lens body. The lens 52 is an amber translucent color lens including a white opaque symbol, and the bulb is flashed at approximately 90 flashes per minute. FIG. 4(b) shows the decal symbol lens 52 in greater detail.

The mobile machine 9 can be any earth-moving machine or the like, including, for example, a tractor-dozer, grader, scraper, loader, excavator, dumper, crawler machine and tractor. The non-engine components to which the grease is supplied include, for example, pins-joints such as a body hoist pivot and a steering rod linkage, chassis mechanisms, universal joints, bearings, ball joints, and the like.

The lubricant grease is a semi-solid to solid product of a dispersion of a thickener in a liquid base lubricant. The liquid base lubricant may be a mineral (petroleum) oil or a synthetic liquid. The thickener is a substance composed of finely divided solid particles, which particles are dispersed in a liquid lubricant to form the grease's structure. The thickener can be a metallic soap or soaps or a non-soap substance such as an organophilic modified clay, a urea compound, carbon black, fibers (such as various metallic scraps) or plates or spheres (such as certain non-soap thickeners), which are insoluble or, at most, only slightly soluble in the liquid lubricant. General requirements are that the solid particles be extremely small, uniformly dispersed, and capable of forming a relatively stable, gel-like structure with the liquid lubricant.

What is claimed is:

1. A system for supplying lubricant grease to a non-engine component of a mobile machine, comprising:
a reservoir for lubricant storing grease;
an output line for supplying lubricant grease from said reservoir to the non-engine component;
an input line for supplying lubricant grease from a lubricant grease source into said reservoir;
a valve associated with said input line, said valve being actuatable from an opened position, at which lubricant grease is allowed to be supplied through said input line and into said reservoir, to a closed position, at which lubricant grease is prevented from being supplied through said input line and into said reservoir; and
a first sensor associated with said reservoir for sensing when said reservoir is filled with lubricant grease to a first level,
wherein said valve and first sensor are interconnected such that when said first sensor senses that lubricant grease in said reservoir is at the first level, with said valve being in the opened position, said valve is automatically actuated to the closed position to prevent additional lubricant grease from being supplied into said reservoir.

2. The system according to claim 1, wherein
said valve comprises a solenoid valve, and
said first sensor comprises a first electrical switch,
such that when lubricant grease in said reservoir is at the first level said electrical switch is opened, whereby electrical power is not supplied to said solenoid valve, and when lubricant grease in said reservoir is beneath said first level said electrical switch is closed, whereby electrical power is supplied to said solenoid valve.

3. The system according to claim 2, further comprising:
a first lamp for being activated when said reservoir is filled with lubricant grease to the first level.

4. The system according to claim 3, further comprising:
a second sensor associated with said reservoir for sensing when said reservoir is filled with lubricant grease to at most a second level, with the second level being beneath the first level; and
a second lamp for being activated when said reservoir is filled with lubricant grease to at most the second level.

5. The system according to claim 4, wherein
said input line includes a coupling for connecting said input line to the source of lubricant grease.

6. A mobile machine comprising:
a non-engine component; and
a system for supplying lubricant grease to said non-engine component, said system including:
(i) a reservoir for storing lubricant grease;
(ii) an output line for supplying lubricant grease from said reservoir to the non-engine component;
(iii) an input line for supplying lubricant grease from a lubricant grease source into said reservoir;
(iv) a valve associated with said input line, said valve being actuatable from an opened position, at which lubricant grease is allowed to be supplied through said input line and into said reservoir, to a closed position, at which lubricant grease is prevented from being supplied through said input line and into said reservoir; and
(v) a first sensor associated with said reservoir for sensing when said reservoir is filled with lubricant grease to a first level,
wherein said valve and first sensor are interconnected such that when said first sensor senses that lubricant grease in said reservoir is at the first level, with said valve being in the opened position, said valve is automatically actuated to the closed position to prevent additional lubricant grease from being supplied into said reservoir.

7. The mobile machine according to claim 6, wherein
said valve comprises a solenoid valve, and
said first sensor comprises a first electrical switch,
such that when lubricant grease in said reservoir is at the first level said electrical switch is opened, whereby electrical power is not supplied to said solenoid valve, and when lubricant grease in said reservoir is beneath said first level said electrical switch is closed, whereby electrical power is supplied to said solenoid valve.

8. The mobile machine according to claim 7, wherein
said system further includes a first lamp for being activated when said reservoir is filled with lubricant grease to the first level.

9. The mobile machine according to claim 8, wherein
said system further includes
(i) a second sensor associated with said reservoir for sensing when said reservoir is filled with lubricant grease to at most a second level, with the second level being beneath the first level; and
(ii) a second lamp for being activated when said reservoir is filled with lubricant grease to at most the second level.

10. The mobile machine according to claim 9, wherein
said input line includes a coupling for connecting said input line to the source of lubricant grease.

11. A grease replenishment system comprising:
a source of lubricant grease; and
a mobile machine including a non-engine component and a system for supplying lubricant grease to said non-engine component, said system including:
(i) a reservoir for storing lubricant grease;
(ii) an output line for supplying lubricant grease from said reservoir to the non-engine component;
(iii) an input line for supplying lubricant grease from said lubricant grease source into said reservoir;
(iv) a valve associated with said input line, said valve being actuatable from an opened position, at which lubricant grease is allowed to be supplied through said input line and into said reservoir, to a closed position, at which lubricant grease is prevented from being supplied through said input line and into said reservoir; and
(v) a first sensor associated with said reservoir for sensing when said reservoir is filled with lubricant grease to a first level,
wherein said valve and first sensor are interconnected such that when said first sensor senses that lubricant grease in said reservoir is at the first level, with said valve being in the opened position, said valve is automatically actuated to the closed position to prevent additional lubricant grease from being supplied into said reservoir.

12. The replenishment system according to claim 11, wherein
said valve comprises a solenoid valve, and
said first sensor comprises a first electrical switch,
such that when lubricant grease in said reservoir is at the first level said electrical switch is opened, whereby electrical power is not supplied to said solenoid valve, and when lubricant grease in said reservoir is beneath said first level said electrical switch is closed, whereby electrical power is supplied to said solenoid valve.

13. The replenishment system according to claim 12, wherein
said system for supplying lubricant grease further includes a first lamp for being activated when said reservoir is filled with lubricant grease to the first level.

14. The replenishment system according to claim 13, wherein
said system for supplying lubricant grease further includes
(i) a second sensor associated with said reservoir for sensing when said reservoir is filled with lubricant grease to at most a second level, with the second level being beneath the first level; and
(ii) a second lamp for being activated when said reservoir is filled with lubricant grease to at most the second level.

15. The replenishment system according to claim 14, wherein
said input line includes a coupling for connecting said input line to said source of lubricant grease.

16. A method for replenishing lubricant grease, comprising:
supplying lubricant grease from a reservoir through an output line to a non-engine component of a mobile machine, thereby depleting lubricant grease from said reservoir;
when lubricant grease within said reservoir falls to a first level, actuating a valve associated with an input line to an opened position and supplying lubricant grease from a lubricant grease source through said input line and into said reservoir, thereby filling said reservoir; and
when a first sensor associated with said reservoir senses that said reservoir becomes filled with lubricant grease to a second level, greater than said first level, automatically actuating said valve to a closed position and thereby preventing additional lubricant grease from being supplied through said input line and into said reservoir.

17. The method according to claim 16, wherein said valve comprises a solenoid valve, and said first sensor comprises a first electrical switch, such that
actuating said valve to an opened position comprises closing said first electrical switch, whereby electrical power is supplied to said solenoid valve, and
automatically actuating said valve to a closed position comprises opening said first electrical switch, whereby electrical power is not supplied to said solenoid valve.

18. The method according to claim 17, further comprising:
activating a first lamp when said reservoir is filled with lubricant grease to the second level.

19. The method according to claim 18, further comprising:
when a second sensor associated with said reservoir senses that said reservoir is filled with lubricant grease to at most the first level, activating a second lamp.

20. The method according to claim 19, further comprising:
releasably coupling said input line to the source of lubricant grease.
